(19) United States
(12) Patent Application Publication
(10) Pub. No.: US 2010/0215825 A1
(43) Pub. Date: Aug. 26, 2010

(54) FIBER-RICH BAKED PRODUCT AND METHOD FOR THE PRODUCTION THEREOF

(75) Inventors: Bernard Boursier, Violaines (FR); Patrick Leroux, Estaires (FR)

Correspondence Address: YOUNG & THOMPSON, 209 Madison Street, Suite 500, Alexandria, VA, 22314, US

(73) Assignee: ROQUETTE FRERES, LESTREM (FR)

(21) Appl. No.: 11/993,025

(22) PCT Filed: Jan. 27, 2006
(86) PCT No.: PCT/FR06/00192

§ 371 Date: Dec. 19, 2007

(30) Foreign Application Priority Data
Jun. 22, 2005 (FR) 05 06341

(51) Int. Cl. A21D 2/18; A23L 1/308; A21D 13/00

(52) U.S. Cl. 426/549; 426/498; 426/504

(57) ABSTRACT

A baked product rich in flour-containing fibres includes from 6 to 20% by weight a mixture of at least one type of starch and an improving agent selected from a group consisting of branched maltodextrins, polydextrins and a polydextrose, wherein the percentages are expressed by weight with respect to a final product.

The present invention relates to a fiber-enriched baked product, comprising flour and a specific improver, the soft character and storage-stability of which are improved. It is in particular directed toward all products comprising flour, such as, in particular, leavened-dough or proofed-dough bakery products, in particular traditional French bread, sandwich breads, English loaves, brioches, bread rolls, Viennese pastries, gateaux, pizza dough, buns, frozen pastry, unleavened pasta, and textured products for human and animal nutrition.

By virtue of its richness in complex carbohydrates and its provision of plant proteins, bread is a food that is essential to a balanced daily diet. Virtually devoid of lipids and providing a moderate energy intake, it makes it possible to improve the lipid-carbohydrate ratio of our diet, which is currently too often unbalanced. The manufacturing processes (fermentation and baking) make it a food that is particularly easy to digest, and a good source of fiber, group B vitamins and minerals. For several years, many food products, including bread, have been enriched in fiber. Dietary fiber denotes not only fibrous materials in the strict sense, but also an entire series of different compounds which occur almost exclusively in foods of plant origin, and which have the common property of not being able to be decomposed by the digestive enzymes of humans. Almost all dietary fiber is carbohydrate polymers. For several years, nutritionists have been interested in a new type of dietary fiber: resistant starch. It is a starch or a starch fraction which is not digested in the small intestine and which is fermented by the bacteria in the colon. Four categories of resistant starch have been identified:
encapsulated starches present in most unrefined starch foods, such as dry vegetables, which are inaccessible to enzymes (RS1),
the granular starch of certain raw foods such as banana or potato, and amylose-rich starches (RS2),
retrograded starches which are found in foods that have been cooked and then refrigerated or frozen (RS3),
chemically modified starches, such as, in particular, etherified or esterified starches (RS4).

The resistant starches proposed in particular by the company National Starch, such as those sold under the name Hi-Maize® are derived from amylose-rich maize varieties and behave like insoluble fiber. RS3-type resistant starches are also proposed under the name Novelose®.

These resistant starches reduce the glycemic response, improve the health of the digestive system by virtue of their prebiotic properties and contribute to the regularity of transit, without having a high calorific value. Unlike conventional plant fiber, these starches have the advantage of not modifying the appearance of the product into which they are incorporated, and in a way constitute a source of fiber invisible to the naked eye. These starches are recommended in many food applications, and in particular in bread, where they are easy to use. Such applications are in particular mentioned in documents U.S. Pat. No. 6,451,367 and US 2004/0234663. However, they have some drawbacks when they are incorporated alone, as a replacement for part of the flour. In fact, problems of a reduction in softness of baked pastry/doughs, and problems with conservation, such as accelerated staining of the crumb, at quite low degrees of incorporation, have been reported in the literature. It therefore appears to be necessary, when it is desired to enrich a baked product in fiber such as resistant starch, to overcome these drawbacks without any sizable modification of the manufacturing processes to which companies are attached.

Having noted this prior art, the applicant company has developed a fiber-enriched baked product and a method for the manufacture thereof, in which a mixture consisting of resistant starch and of an improver chosen from the group consisting of branched maltodextrins, polydextrins and polydextrose is incorporated as a replacement for part of the flour.

The applicant company has in fact found, after many trials, that the combination of resistant starch and of a particular improver makes it possible, by virtue of their complementarity, to correct the drawbacks of each of them. Resistant starch used alone has a negative impact on the softness of doughs, and on the crustiness of the crust when it is desired. Branched maltodextrins, for their part, have the drawback of requiring, at incorporation rates of greater than 3% by weight, the addition of a reducing agent such as cysteine, for example, such that the dough can be worked normally.

By virtue of this specific combination, fiber-enriched baked products can be manufactured according to conventional methods, thereby obtaining products whose softness is substantially improved and whose conservation is entirely satisfactory, while at the same time allowing incorporation rates that are substantially increased, and in any event greater than 3% by weight relative to the finished product.

The subject of the present invention is therefore a fiber-enriched baked product comprising flour, characterized in that it comprises from 6% to 16% of a mixture of at least one resistant starch and of at least one improver chosen from the group consisting of branched maltodextrins, polydextrins and polydextrose, these percentages being expressed by weight relative to the finished product.

According to the present invention, the term “fiber-enriched” is intended to mean baked products which comprise at least 6 g of fiber per 100 g of finished product. The determination of the fiber content is carried out according to AOAC method 2001-03, Gordon and Okuma. The baked product in accordance with the invention advantageously comprises from 3% to 8% by weight of resistant starch and from 3% to 8% of improver.

According to a preferred variant of the invention, the baked product is characterized in that the resistant starch/improver ratio of the mixture is between 25/75 and 75/25, and even better still 30/70 and 70/30. It is preferably of the order of 40/60.

The term “branched maltodextrins” is intended to mean the specific maltodextrins as described in patent EP 1 006 128-B1, of which the applicant is the proprietor. These branched maltodextrins have the advantage of representing a source of indigestible fiber beneficial to the metabolism and to intestinal equilibrium. In particular, use may be made, as improver, of branched maltodextrins having between 15% and 35% of 1-6 glucosidic linkages, a reducing sugar content of less than 10%, a molecular weight Mw of between 4000 and 6000 g/mol and a number-average molecular mass Mn of between 2000 and 4000 g/mol.

Certain subfamilies of branched maltodextrins described in said application can also be used in accordance with the invention. They are in particular low-molecular-weight branched maltodextrins having a reducing sugar content of between 5% and 20% and a molecular mass Mn of less than 2000 g/mol. These maltodextrins may, of course, be used alone or as a mixture with other improvers in accordance with the invention. Very good results have been obtained with a baked product comprising from 4% to 8%, preferably between 4% and 6% of resistant starch, and from 4% to 8%, preferably between 4% and 7% of branched maltodextrins.

The term “pyrodextrins” denotes the products obtained by heating of starch brought to a low moisture content, in the presence of acidic or basic catalysts, and generally having a molecular weight of between 1000 and 6000 daltons. This dry-roasting of the starch, most commonly in the presence of an acid, brings about both a depolymerization of the starch and a rearrangement of the starch fragments obtained, resulting in highly branched molecules being obtained. This definition is in particular aimed at “indigestible” dextrins with an average molecular weight of the order of 2000 daltons.

As regards the resistant starches, use may be made, without distinction, of natural resistant starches or resistant starches obtained by chemical and/or physical modification. Use will preferably be made of a resistant starch derived from starch having an amylose content of greater than 50%. The products sold by National Starch under the name Hi-Maize® are particularly suitable, as are the Eurylon® amylose-rich starches sold by the applicant.

The baked products according to the invention denote articles manufactured, as appropriate, by, for example, oven baking, cooking in water, or baking-extrusion, of doughs produced by kneading a starting flour and water, to which other adjuvants commonly used, such as, in particular, yeast, salt, sugars, sweeteners, dairy products, fats, emulsifiers, spices, dry fruit, flavorings or amylolytic enzymes, may be added as needed.

According to an advantageous variant of the invention, the dough does not comprise any fat, since the combination of resistant starch and improver according to the invention has the additional advantage of partially or completely replacing the fats commonly used. Furthermore, when the intention is to prepare products with a low fat content, one is generally confronted with a loss of softness of the products, as is in particular the case for brioches. Under the conditions of the present invention, the specific combination of resistant starch and of improver has the advantage of compensating for the loss of softness of a product less rich in fats, by using few or no additional additives.

The starting flour generally denotes wheat flours, which may be supplemented or partially replaced with rye, maize or rice flour, in particular. The term “wheat flours” is intended to mean the conventional flours of the flour trade, from white flour to whole flour.

The invention relates, without distinction, to all the proofed or unproofed, or leavened or unleavened dough varieties. The products obtained from leavened doughs are, for example, breads, special breads, Viennese breads, brioches products, pizzas and hamburger rolls. The products obtained from proofed doughs are, for example, biscuits, cookies, muffins, cakes and other gateaux, and products based on puff pastry. The unleavened doughs denote in particular pastas (spaghetti, tagliatelle, macaroni, noodles, and the like) in all their forms prepared from hard or soft wheat flours. The invention also applies to extruded products such as snacks, breakfast cereals, crackers, and any textured product comprising flour.

The baked product according to the invention may be manufactured according to any conventional industrial process. A dough comprising a mixture of flour, water, the mixture of resistant starch and of improver according to the invention, and optionally a rising agent is prepared. The amounts of flour, of water and of rising agent are readily determined by those skilled in the art according to the type of baked product desired. This dough may be leavened or unleavened as appropriate. The dough used in the method according to the invention will comprise resistant starch and the improver as a replacement for a part of the flour, in proportions such that the finished product after baking comprises from 3% to 8% by weight of resistant starch and from 3% to 8% by weight of branched maltodextrins. Below 3%, the functionalities of each ingredient cannot be demonstrated. Above 8%, the organoleptic qualities and the machinability of the doughs begin to be negatively modified.

Of course, the dough used to prepare the baked products according to the invention may comprise any ingredient that is suitable and generally used by those skilled in the art, and may be formulated without distinction according to the various consumer requirements and the industrial equipment.

A subject of the present invention is therefore also a method for the manufacture of a fiber-enriched baked product consisting in:
forming a dough comprising flour, at least one resistant starch and at least one improver,
kneading this dough,
optionally leaving the dough to rise,
baking the dough so as to obtain said baked product,
   characterized in that said baked product comprises from 3% to 8% by weight of resistant starch and from 3% to 8% by weight of an improver chosen from the group consisting of branched maltodextrins, (hydrogenated or nonhydrogenated) polydextrose and polydextrins alone or as a mixture with one another, these percentages being expressed by weight relative to the finished product.

The applicant has also noted that some plant fiber can perform the same functions as a resistant starch, and can completely or partially replace said resistant starch. Said fiber is in particular pea, potato or wheat fiber, pea fiber being preferred.

Hydrocolloids such as guar gum, xanthan gum and other gums capable of modifying the availability of water in the dough, and of allowing the replacement of all or part of the fats, may also be suitable. Thus, mixtures of guar or xanthan gums with the improver according to the invention and, optionally, the resistant starch make it possible to prepare fiber-enriched, reduced-fat breadmaking products. As will be exemplified, moreover, it has been possible, in accordance with the invention, to prepare brioches with an approximately 40% reduced fat content, and with a fiber content of 7%, the brioches obtained being entirely comparable to the products prepared according to the methods of the prior art.

The subject of the present invention is therefore a fiber-enriched baked product comprising flour, characterized in that it comprises from 3% to 20% by weight of a mixture of at least one plant fiber, preferably pea fiber, and of at least one improver chosen from the group consisting of branched maltodextrins, pyrodextrins and polydextrose, these percentages being expressed by weight relative to the finished product.

According to a preferred variant, the baked product according to the invention comprises from 1% to 8% by weight of plant fiber, preferably pea fiber, and from 3% to 8% by weight of an improver chosen from the group consisting of branched maltodextrins, polydextrose and polydextrins alone or as a mixture with one another, these percentages being expressed by weight relative to the finished product, branched maltodextrins being preferred. Of course, the method for obtaining such a fiber-enriched baked product is unchanged relative to the abovementioned method which uses resistant starches.

According to another variant of the present invention, said baked product comprises a mixture of improver and of at least one hydrocolloid, preferably a guar and/or xanthan gum. When the improver represents from 3% to 6% of the baked product, the presence of guar gum is sufficient to ensure the preparation of a correct dough. Above 6% of improver, the presence of cysteine together with the guar gum becomes necessary in order to adjust the dough texture. A subject of the invention is therefore also a fiber-enriched baked product comprising flour, characterized in that it comprises from 4% to 20% by weight of a mixture of guar and/or xanthan gum and of at least one improver chosen from the group consisting of branched maltodextrins and pyrodextrins, these percentages being expressed by weight relative to the finished product. According to one variant of the present invention, the improver represents from 3% to 15% by weight of the finished product, the gum being present in the finished product in an amount of less than or equal to 2%, preferably between 0.5% and 1.5% by weight.

The invention will now be understood more clearly upon reading the examples which follow and the figure which relates thereto, which are nonlimiting illustrations.

### EXAMPLE 1

### Manufacture of Fiber-Enriched Breads According to the Invention

Breads are prepared in accordance with the invention, using a mixture of Eurylon® 6 resistant starch (maize starch containing 60% amylose) and of branched maltodextrins, without the addition of reducing agent. The dough formulas used are given in detail in the table below (the percentages indicate the proportion in the finished product):

| | Trial 1 | | Trial 2 | | Trial 3 | | Trial 4 | |
|---|---|---|---|---|---|---|---|---|
| Leforest flour (g) | 2000 | | 2000 | | 2000 | | 2000 | |
| Vital gluten (g) | 90 | | 100 | | 110 | | 110 | |
| Branched maltodextrins (g) | 100 (3.68%) | | 210 (6.58%) | | 250 (7.69%) | | 250 (7.68%) | |
| Eurylon ®6 (g) | 150 (4.29%) | | 150 (4.36%) | | 150 (4.27%) | | 0 | |
| Yeast (g) | 70 | | 70 | | 70 | | 70 | |
| Salt (g) | 40 | | 40 | | 40 | | 40 | |
| 1% ascorbic acid (ml) | 0.2 | | 0.2 | | 0.2 | | 0.2 | |
| Water | 1260 | | 1200 | | 1200 | | 1200 | |
| Enzyme (g) | 0.2 | | 0.2 | | 0.2 | | 0.2 | |
| V1 spiral kneading machine | 2 | min | 2 | min | 2 | min | 2 | min |
| V2 spiral kneading machine | 9 | min | 9 | min | 9 | min | 9 | min |
| T° C. end of kneading | 33.2° | C. | 33.5° | C. | 33.3° | C. | 33.6° | C. |
| Appearance of the dough | correct | | correct | | slightly | | tacky | |
| | | | | | tacky | | | |
| Placed in an oven | correct | | correct | | lacks | | lacks | |
| | | | | | tolerance | | tolerance | |
| Volume of a bread | 2130 | ml | 2220 | ml | 1740 | ml | 1700 | ml |
| Weight after baking | 415 | g | 414 | g | 422 | g | 422.5 | g |

| | | | | |
|---|---|---|---|---|
| Fiber content/100 g | 6.55 | 9.48 | 10.29 | 8.49 |

These trials demonstrate that fiber-rich breads comprising approximately 4% of resistant starch and approximately 6% of branched maltodextrins have an optimal volume, without the dough being tacky before baking. Lower incorporation rates are still satisfactory in terms of the use of the dough and the bread volume, but the fiber content of the final product is lower. Above 7% of branched maltodextrins, the pack becomes slightly tacky (trial 3). Without resistant starch (trial 4), the dough is very tacky.

### EXAMPLE 2

### Preparation of Sandwich Breads; Conservation Test

Sandwich breads are manufactured using a mixture of Hi-Maize® 958 or Eurylon® 6 resistant starch and of branched maltodextrins. A conservation test is carried out so as to assess the change in the crumb after conservation. The formulas used are reiterated in the table below:

| | A | B | C | D |
|---|---|---|---|---|
| Leforest flour (g) | 1840 | 1840 | 1840 | 1840 |
| Vital gluten (g) | 120 | 120 | 120 | 120 |
| Eurylon ®6 (g) | 150 (3.94%) | | | |
| Hi-Maize ® 958 | | 150 (3.93) | 200 (5.26) | 350 (9.06) |
| Branched maltodextrins | 200 (5.67%) | 200 (5.66%) | 150 (4.26%) | 0 |
| Soybean oil | 150 | 150 | 150 | 150 |
| Powdered skimmed milk | 100 | 100 | 100 | 100 |
| Yeast | 70 | 70 | 70 | 70 |
| Salt | 40 | 40 | 40 | 40 |
| Enzyme | 0.2 | 0.2 | 0.2 | 0.2 |
| 1% ascorbic acid (ml) | 0.1 | 0.1 | 0.1 | 0.1 |
| Water | 1160 | 1160 | 1160 | 1160 |
| Weight of the bread before | 500 | 500 | 500 | 500 |
| baking (g) | | | | |
| Weight of the bread after | 437.3 | 438.1 | 437 | 444 |
| baking | | | | |
| Conservation | | | | |
| After 8 days at 4° C. | | | | |
| Firmness (N) | 7.9 | 7.9 | 11 | 17.6 |
| Elasticity (%) | 62 | 62 | 60 | 60 |
| After freezing-thawing | | | | |
| Firmness (N) | 4.7 | 3.9 | 4.7 | 8.2 |
| Elasticity (%) | 67 | 65 | 67 | 65 |
| % total fiber of the | 8.29 | 9.17 | 8.88 | 7.83 |
| formula | | | | |
| Resistant starch/branched | 38 | 38 | 55 | 100 |
| maltodextrin ratio | 62 | 62 | 45 | 0 |

Results: These trials clearly demonstrate that, when the breads comprise only resistant starch, the firmness is virtually doubled compared with breads comprising a mixture of resistant starch and branched maltodextrins. A resistant starch/branched maltodextrin ratio of approximately 40/60 (trials A and B) gives results that are entirely correct in terms of firmness and elasticity of the dough. The firmness of the breads increases as the resistant starch incorporation rate increases. Moreover, it is possible to manufacture breads with branched maltodextrins without the addition of reducing agent according to the prior art.

### EXAMPLE 3

### Manufacture of Fiber-Enriched Sandwich Breads According to the Invention

Breads were prepared in accordance with the invention, using a mixture of pea fiber and of branched maltodextrins, without the addition of reducing agent.

Trial 1 is a control according to the conventional formula with dextrose. Trial 2 is a control comprising only branched maltodextrins. Trial 3 is a formula in accordance with the invention. The dough formulas used are described in detail in the table below (the percentages indicate the proportion in the finished product). The doughs are baked in a rotary oven at 200° C. for 25 minutes after proofing times of 2 h 15 min for trials 1 and 2, and 1 h 30 for trial 3. The water contents after baking and 24 hours of storage are measured.

| | Trial 1 | | Trial 2 | | Trial 3 | |
|---|---|---|---|---|---|---|
| Leforest flour (g) | 2020 | | 2020 | | 2020 | |
| Vital gluten (g) | 120 | | 120 | | 120 | |
| Branched maltodextrins (g) | 0 | | 200 | | 150 | |
| Pea fiber (g) | 0 | | 0 | | 50 | |
| Dry yeast (g) | 30 | | 30 | | 30 | |
| Salt (g) | 40 | | 40 | | 40 | |
| 1% ascorbic acid (ml) | 0.1 | | 0.1 | | 0.1 | |
| Water | 1190 | | 1190 | | 1190 | |
| Enzyme (g) | 0.3 | | 0.3 | | 0.3 | |
| Powdered skimmed milk | 70 | | 70 | | 70 | |
| Rapeseed oil | 150 | | 150 | | 150 | |
| Calcium propionate | 10 | | 10 | | 10 | |
| V1 spiral kneading machine | 1 | min | 1 | min | 1 | min |
| V2 spiral kneading machine | 10 | min | 18 | min | 11 | min |
| Proofing time at 30° C. | 2 h 15 | | 2 h 15 | | 1 h 30 | |
| and 85% relative humidity | | | | | | |
| Weight of the dough pieces | 450 | g | 450 | g | 450 | g |

| | | | |
|---|---|---|---|
| Water content after 24 hours | 39.25 | 39.02 | 37.58 |
| (%) | | | |
| Aw after 24 hours | 0.948 | 0.964 | 0.964 |

Trial 1: 1 + 10 min are necessary to bind the dough and obtain a correct texture (kneading for a shorter period of time gives a poorly bound dough of tacky texture).
Trial 2: “negative” control: without the addition of insoluble fiber, 1 + 18 min are necessary to bind the dough.
Trial 3: branched maltodextrins + pea fiber: 1 + 11 min are necessary to bind the dough, i.e. a time comparable to the conventional formula of trial 1.

### EXAMPLE 4

### Manufacture of Reduced-Fat Brioches According to the Invention

Fiber-enriched, reduced-fat brioches comprising a mixture of improver (branched maltodextrins) and of guar gum are prepared.

The formula used is the following:

| | Composition as % | Composition as % |
|---|---|---|
| | of the weight of | of the finished |
| | flour | product |
| Wheat flour | 100 | 48.29 |
| Vital gluten | | |
| Glucidex ® 2 maltodextrins | 3.41 | 1.83 |
| Butter | 13.66 | 6.55 |
| Branched maltodextrins | 11.71 | 6.27 |
| Guar gum | 1.37 | 0.77 |
| Whole egg | 24.39 | 3.58 |
| Meliose 700 glucose syrup | 17.07 | 6.74 |
| Pressed yeast | 4.39 | 0.64 |
| Salt | 1.95 | 1.10 |
| Ascorbic acid | 0.02 | 0.01 |
| Enzyme | 0.02 | 0.01 |
| Cysteine | 0.03 | 0.02 |
| Water at 25° C. | 24.39 | 21.90 |

The cysteine is dissolved in the water. All the powders are mixed, and then the other ingredients are added. The kneaded mixture is then baked, after having risen for two hours at 35° C., in an oven at 190° C. for 23 minutes.

The brioches obtained comprise, compared with the conventional recipe, 42% less fat, a 12% reduction in calories, and more than 7% of fiber.

1. A fiber-enriched baked product comprising flour, characterized in that it comprises from 6% to 20% by weight of a mixture of at least one resistant starch and of at least one improver chosen from the group consisting of branched maltodextrins, pyrodextrins and polydextrose, these percentages being expressed by weight relative to the finished product.

2. The baked product as claimed in claim 1, characterized in that it comprises from 3% to 8% of resistant starch and from 3% to 8% of said improver, these percentages being expressed by weight relative to the finished product.

3. The baked product as claimed in claim 1, characterized in that said improver consists of branched maltodextrins.

4. The baked product as claimed in claim 1, characterized in that the resistant starch/improver ratio of said mixture is between 75/25 and 25/75.

5. The baked product as claimed in claim 1, characterized in that it has a fiber content of at least 6 g/100 g of finished product.

6. A method for the manufacture of a fiber-enriched baked product, consisting in
forming a dough comprising flour, at least one resistant starch and at least one improver,
kneading this dough,
optionally leaving the dough to rise,
baking the dough so as to obtain said baked product,
characterized in that said baked product comprises from 3% to 8% by weight of resistant starch and from 3% to 8% by weight of an improver chosen from the group consisting of branched maltodextrins, polydextrose and polydextrins alone or as a mixture with one another, these percentages being expressed by weight relative to the finished product.

7. The method as claimed in claim 6, characterized in that said resistant starch is a starch having an amylose content of greater than or equal to 50%.

8. The method as claimed in claim 6, characterized in that said improver consists of branched maltodextrins.

9. A fiber-enriched baked product comprising flour, characterized in that it comprises from 4% to 20% by weight of a mixture of at least one plant fiber and of at least one improver chosen from the group consisting of branched maltodextrins and pyrodextrins, these percentages being expressed by weight relative to the finished product.

10. The baked product as claimed in claim 9, characterized in that it comprises from 1% to 8% of a pea fiber and from 3% to 8% of branched maltodextrins, these percentages being expressed by weight relative to the finished product.

11. A fiber-enriched baked product comprising flour, characterized in that it comprises from 4% to 20% by weight of a mixture of guar and/or xanthan gum and of at least one improver chosen from the group consisting of branched maltodextrins and pyrodextrins, these percentages being expressed by weight relative to the finished product.
